(19) United States
(12) Patent Application Publication
(10) Pub. No.: US 2015/0324844 A1
(43) Pub. Date: Nov. 12, 2015

(54) ADVERTISING MARKETPLACE SYSTEMS AND METHODS

(71) Applicant: BILIN TECHNOLOGY, INC., Boston, MA (US)

(72) Inventors: Lin Wang, Dover, MA (US); Jiankuan Ye, Lexington, MA (US)

(21) Appl. No.: 14/705,696

(22) Filed: May 6, 2015

Related U.S. Application Data
(60) Provisional application No. 61/990,928, filed on May 9, 2014.

(51) Int. Cl. G06Q 30/02

(52) U.S. Cl. CPC G06Q 30/0255

(57) ABSTRACT

According to at least one embodiment, a system including a memory, at least one processor coupled to the memory, and a user identifier component is provided. The user identifier component is executable by the at least one processor. The user identifier component is configured to receive historical usage data; determine fingerprints from the historical usage data; identify clusters of fingerprints having a calculated similarity greater than a threshold; and associate the clusters with a user.

### RELATED APPLICATIONS

This application claims priority under 35 U.S.C. §119(e) to U.S. Provisional Application Ser. No. 61/990,928, titled “ADVERTISING MARKETPLACE SYSTEMS AND METHODS,” filed on May 9, 2014, which is hereby incorporated herein by reference in its entirety.

### BACKGROUND

1. Technical Field

The technical field of this disclosure relates generally to advertising systems and, more particularly, to advertising systems and methods that deliver advertisements to potential consumers via computer technology.

2. Background Discussion

Conventional internet based advertising systems download advertisements in real time or near real time to devices accessing the internet. These advertisements are sometimes targeted to devices based on content previously accessed using the device. Further, these advertisements may be downloaded over cellular connections to mobile devices, such as smart phones.

### SUMMARY

Embodiments disclosed herein manifest an appreciation that conventional internet based advertising systems suffer from a variety of shortcomings. For example, some conventional systems target advertisements to devices based on historical content delivered to the device. As a result, advertisements delivered to devices by these conventional systems may not be relevant to a user currently operating the device. Other conventional systems deliver advertisements via multiple channels according to plans generated by marketing personnel. These plans often result in sub-optimal budget allocation. Still other conventional systems deliver advertisements in real time or near real time and, as a result, cause the user to sometimes experience latency when using a device. Other conventional systems deliver advertisements download a large volume of advertisement data over cellular connections, thereby consuming large quantities of user's allotted data.

Aspects and embodiments disclosed herein are directed to a computer system that executes a variety of novel processes that facilitate effective online advertising. For example, according to one aspect, an advertising marketplace system includes facilities (e.g., executable code and data housed in data structures) configured to monitor user activity and identify a particular user whose activity spans two or more devices. According to this aspect, the advertising marketplace system may calculate a likelihood that a two or more instances of detected user activity were conducted by a single user and use this user identification information to inform subsequent advertising processes.

According to other aspects, the advertising marketplace system includes facilities configured to analyze historical data descriptive of previously conducted (or ongoing) advertisement campaigns to provide recommendations to improve future advertisement campaigns. For example, according to one aspect, the advertising marketplace system creates an optimization model based on the analyzed historical data and executes the model to predict a mix of campaign activities that best utilizes a limited advertising budget to achieve one or more campaign goals.

According to other aspects, the advertising marketplace system includes facilities configured to predict impressions that will occur in the future and pre-sell the predicted impressions within a future time bidding (FTB) process. For example, according to one aspect, the advertising marketplace system monitors current user activity to predict that user activity resulting in an impression will occur in the near future and offers the predicted impression for sale. Upon purchase of the predicted impression, the advertising marketplace system executes additional processing to ready itself to respond to the predicted impression once it is received, thereby decreasing latency.

According to other aspects, the advertising marketplace system includes facilities configured to manage advertisement content. For example, according to one aspect, the advertising marketplace system monitors connections to devices and caches advertisement content on devices via non-cellular network connections, where such connections are available. In this way, the advertising marketplace system conserves cellular data usage and decreases advertisement delivery latency.

Still other aspects, embodiments and advantages of these example aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a block diagram of an advertising marketplace within which an advertising marketplace system may operate;

FIG. 2 is a schematic diagram of logical and physical components of an advertising marketplace system;

FIG. 3 is a schematic diagram of a computer system;

FIG. 4 is a flow diagram illustrating a user identification process executed by an advertising marketplace system;

FIG. 5 is a flow diagram illustrating a campaign planning process executed by an advertising marketplace system;

FIG. 6 is a flow diagram illustrating an impression pre-selling process executed by an advertising marketplace system;

FIG. 7 is a flow diagram illustrating an advertisement caching process executed by an advertising marketplace system; and

FIG. 8 is a flow diagram illustrating an RTB process executed within an advertising marketplace.

### DETAILED DESCRIPTION

Some embodiments disclosed herein include apparatus and processes that implement an advertising marketplace system with a variety of features not available in conventional advertising systems. For example, according to some embodiments, an advertising marketplace system is configured to analyze data received from a plurality of programmable devices to determine a probability that an identified user used the devices within a particular time frame. In these embodiments, the advertising marketplace system analyzes data generated by its execution of real time bidding (RTB) processes. Examples of the types of data analyzed by the advertising marketplace system include user location, content accessed, time of access, and other information. Examples of the devices that transmit the data to the advertising marketplace system include mobile phones, tablet computers, and desktop computers. Using the data received from these devices, the advertising marketplace system attempts to identify users whose activity spans multiple devices. Additional examples in accord with these aspects and embodiments are described further below.

According to other embodiments, the advertising marketplace system is configured to analyze data descriptive of historical advertising campaigns to increase the effectiveness of future advertising campaigns. In these embodiments, the advertising marketplace system first derives performance indicators from the historical data. Next, in these embodiments, the advertising marketplace system constructs one or more optimization problems formulated to solve for a budgetary allocation across multiple advertising channels that satisfies some goal criteria. These one or more optimization problems may be formulated as linearly or nonlinearly constrained optimization problems. The goal criteria may be defined in terms of the performance indicators. For instance, the goal criteria may be to maximize conversion rates. Examples of the advertising channels modeled in the one or more optimization problems include mobile, social, video, and display channels.

In some embodiments, the advertising marketplace system periodically re-executes the performance indicator derivation and optimization processes described above to continuously improve the advertising campaigns. This periodic re-execution may incorporate feedback from recently executed advertising campaigns as new historical data to increase the quality of the solutions provided by solving the one or more optimization problems. In this way, the advertising marketplace system allows advertisers to run campaigns that leverage synergies across multiple advertising channels to continuously improve their advertising efforts. Additional examples in accord with these aspects and embodiments are described further below.

According to other aspects and embodiments, the advertising marketplace system is configured to reduce latency experienced by devices through pre-selling predicted impressions. In these embodiments, the advertising marketplace system predicts characteristics of predicted impressions and pre-sells the predicted impressions in an FTB process. The FTB process executes one or more actions conventionally executed by an RTB process, but the FTB process executes at least some actions prior to receipt of the predicted impression. Thus when the predicted impression is received, there are fewer remaining steps to be executed to successfully deliver an advertisement. In this way, the advertising marketplace system facilitates successful advertisement delivery and low latency interactions between users and their devices, even in locations where there is a dearth of wireless data bandwidth available to the devices. Additional examples in accord with these aspects and embodiments are described further below.

According to other aspects and embodiments, the advertising marketplace system is configured to reduce cellular data bandwidth consumed by delivery of advertisements. In these embodiments, the advertising marketplace monitors the network connections maintained by devices. When the advertising marketplace system determines that a device is connected to it via a non-cellular connection, such as a Wi-Fi or wired connection, the advertising marketplace system downloads advertisements to the device. The advertisements are cached in a data store maintained in the device and presented in the future, in response to normal device usage by a user of the device. In this way, the advertising marketplace system increases successful, low latency delivery and presentation of even large and sophisticated advertisements without taxing limited data plans purchased by users. Additional examples in accord with these aspects and embodiments are described further below.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

### Advertising Marketplace

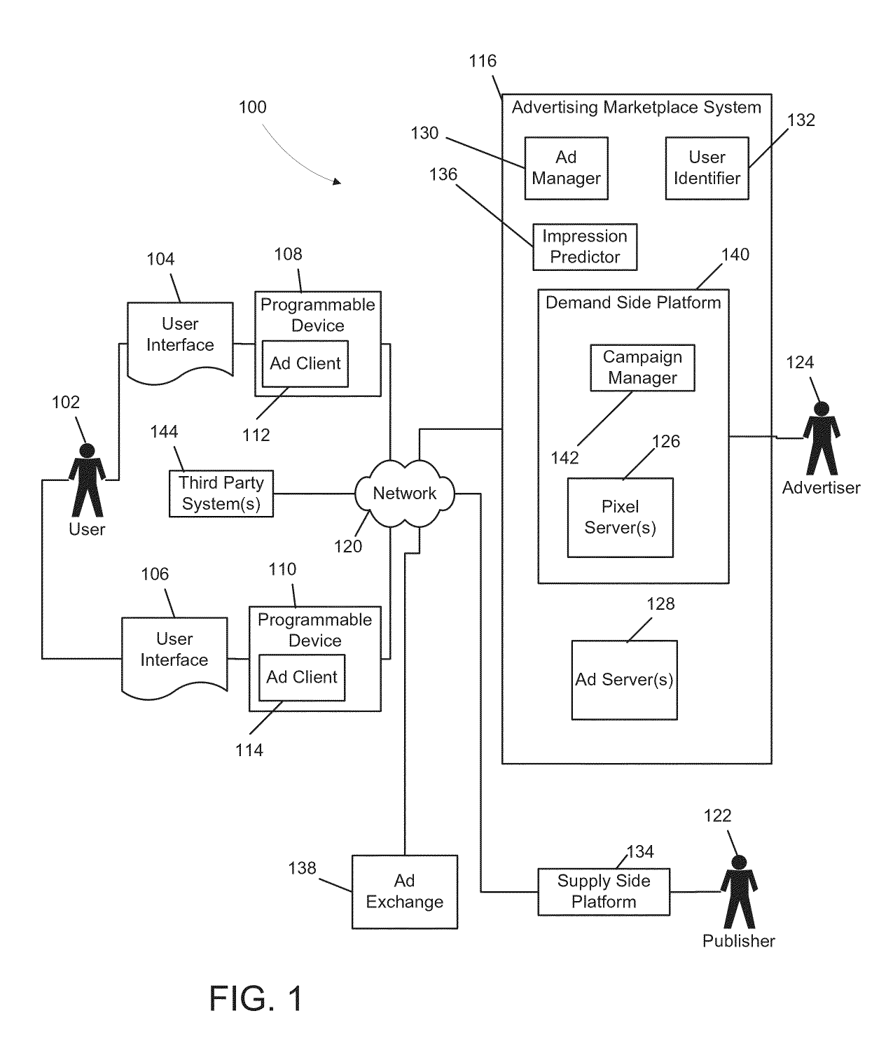

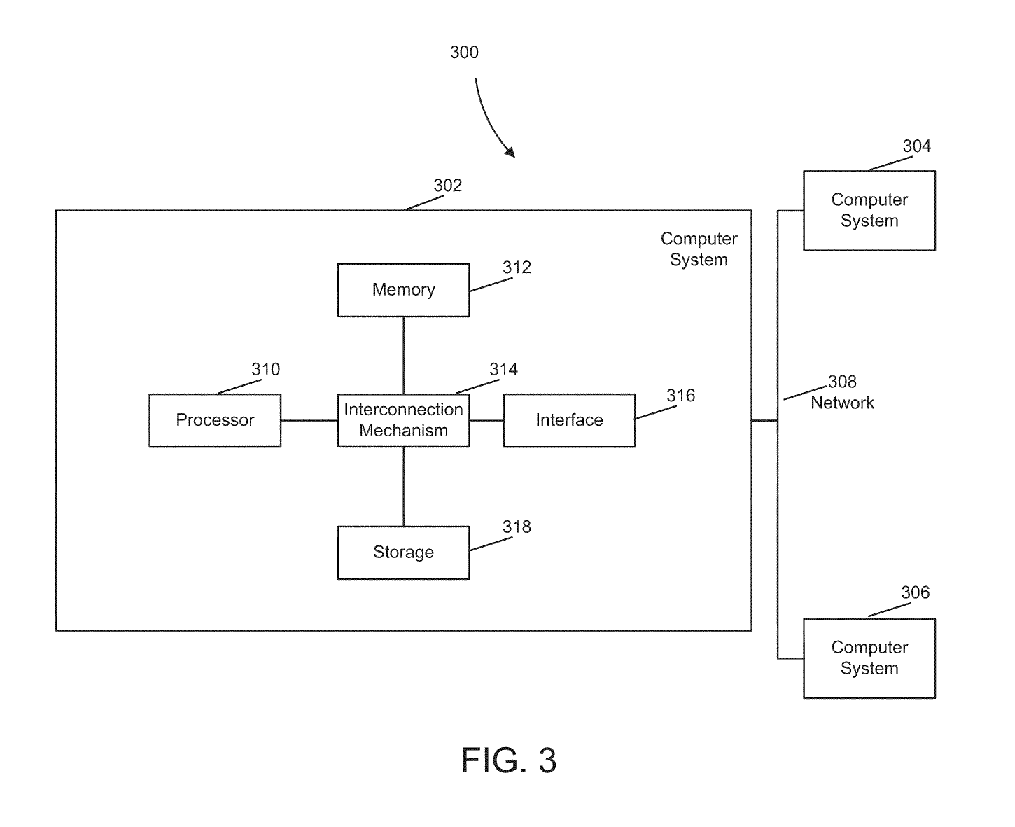

Some embodiments disclosed herein implement an advertising marketplace system using one or more computer systems, such as the computer systems described below with reference to FIG. 3. According to these embodiments, an advertising marketplace system is configured to execute a variety of advertising automation processes that facilitate automatic placement of advertisement content. FIG. 1 illustrates an example advertising marketplace 100. As shown in FIG. 1, the advertising marketplace 100 includes the following components: a user 102, a publisher 122, an advertiser 124, user interfaces 104 and 106 respectively provided by programmable devices 108 and 110, an advertising marketplace system 116, one or more third party systems 144, an ad exchange 138, a supply side platform (SSP) 134, and a communications network 120. The programmable device 108 includes an ad client 112. The programmable device 110 includes an ad client 114. The advertising marketplace system 116 includes an ad manager 130, a user identifier 132, an impression predictor 136, an enhanced demand side platform (DSP) 140, and one or more ad servers 128. The enhanced demand side platform includes a campaign manager 142 and one or more pixel servers 126.

As illustrated in FIG. 1, the programmable devices 108 and 110, the advertising marketplace system 116, the supply side platform 134, the ad exchange 138, and the third party systems 144 exchange (i.e. transmit or receive) information via the network 120. The network 120 may include any communication network through which computer systems exchange information. For example, the network 120 may be a public network, such as the Internet, and may include other public or private networks such as LANs, WANs, extranets, intranets, and cloud computing systems. The network 120 may also include cellular networks such as LTE, 4G, HSDPA/HSUPA, TD-SCDMA, W-CDMA, CMDA, Wi-Fi, Bluetooth, EvDO, GSM, and iDEN networks. Although shown as a single network in FIG. 1, in some embodiments, the network 120 includes a plurality of communication networks.

In an embodiment illustrated by FIG. 1, the user 102 interacts (e.g., provides input or receives output) with the user interfaces 104 and 106. The publisher 122 interacts with the supply side platform 134. The advertiser 124 interacts with the demand side platform 140. Each programmable device 108 and 110 is configured to respectively implement each user interface 104 and 106. In some embodiments illustrated by FIG. 1, the user interfaces 104 and 106 are browser-based user interfaces. In other embodiments, the user interfaces 104 and 106 are implemented as components within social media systems, such as the FACEBOOK social networking system available online from Facebook Inc. of Menlo Park, Calif. In still other embodiments, the user interfaces 104 and 106 are specialized client programs that execute outside of a browser environment, such as an application program executing on a mobile device. The user interfaces 104 and 106 may be implemented using a variety of technologies and may include sundry elements (e.g., screens, windows, buttons, boxes, etc) arranged according to various user interface metaphors. As described further below, the user interfaces 104 and 106 provide advertisements to the user 102 in accord with various embodiments.

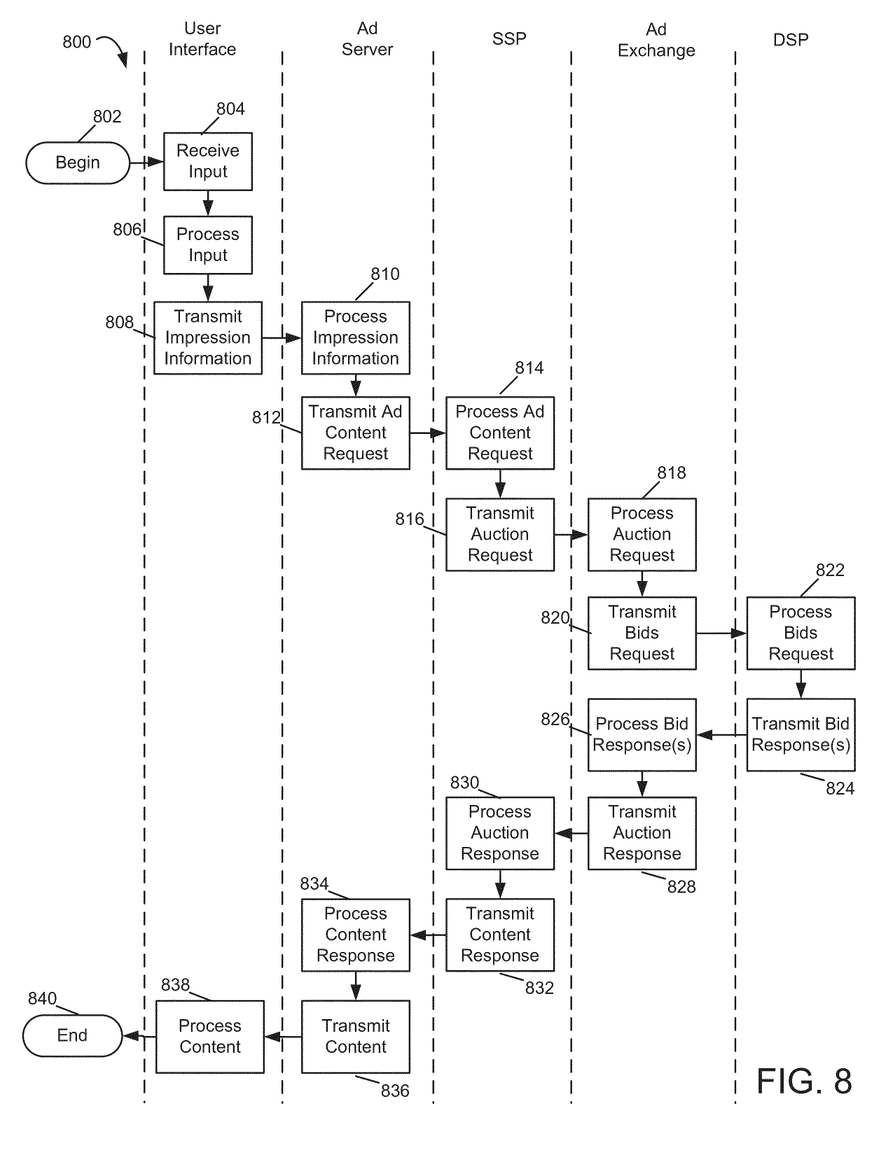

According to various embodiments, the advertising marketplace 100 includes components configured to provide the user 102 with advertisements via the user interfaces 104 and 106. These advertisements may be identified and provided to the user 102 via execution of an RTB process that involves components of the advertising marketplace 100. FIG. 8 illustrates one example of an RTB process 800. The RTB process 800 begins at 802.

In act 804, the user interface 104 receives input from the user 102 selecting content hosted by a third party system 144. In response to receiving the input, the user interface 104 requests and processes the selected content from the third party system 144, in act 806. In this example, the selected content includes a tagged element (e.g., a tagged pixel) supplied by the pixel server 126 that redirects the user interface 104 from the third party system 144 to the ad server 128.

The tagged element may be associated with code that causes the user interface 104 to gather and transmit impression information to the ad server 128 in act 808. The impression information may be descriptive of the programmable device 108, the user interface 104, the user 102, and the hosted content selected by the user 102.

In act 810, the ad server 128 receives and processes the impression information. In act 812, responsive to receiving and processing the impression information, the ad server 128 transmits a request for advertisement content to the supply side platform 134. The request for advertisement content may include information derived from impression information.

As illustrated in FIG. 1, the supply side platform 134 provides publishers, such as the publisher 122, with the ability to manage their advertisement space to increase profitability. Specific functions provided by the supply side platform 134 include yield management and the ability to manage multiple public and private networks.

Continuing with the example illustrated in FIG. 8, the supply side platform 134 receives and processes the request for advertisement content in act 814. In act 816, the supply side platform 134 transmits an auction request to the ad exchange platform 138. The auction request may include information derived from the impression information.

In act 818, the ad exchange receives and processes the auction request. More particularly according to the act 818, in response to receiving the auction request, the ad exchange platform 138 executes a real time auction in which advertisers, such as the advertiser 124, bid for the impression (i.e., the opportunity to place advertisement content within the user interface 104 along with the hosted content selected by the user 102). In act 820, the ad exchange platform 138 initiates the real time auction by transmitting request for bids to the demand side platform 140. The request for bids may include information derived from the impression information.

In this example, the demand side platform 140 enables advertisers, such as the advertiser 124, to configure impression valuation rules that calculate bids based on the characteristics of an impression. In act 822, the demand side platform 140 receives and processes the bids request. More particularly, in the act 822, in response to receiving the request for bids from the ad exchange platform 138, the demand side platform 140 calculates bids based on the information derived from the impression information. In act 824, the demand side platform 140 responds to the request for bids by transmitting one or more bid responses to the ad exchange platform 138. The one or more bid responses may include bid information descriptive of the calculated bids and information identifying advertisement content associated with the calculated bids.

In act 826, the ad exchange platform 138 receives and processes the one or more bid responses. More particularly, in the act 826, in response to receiving the one or more bid responses from the demand side platform 138, the ad exchange platform 138 identifies and records a winning bid. In act 828, the ad exchange platform 138 transmits an auction response to the supply side platform 134. The auction response includes information descriptive of the winning bid and the advertisement content associated therewith.

In act 830, the supply side platform 134 receives and processes the auction response. In response to receiving and processing the auction response, the supply side platform 134 transmits an advertisement content response to the ad server 128 in act 832. The advertisement content response may include information identifying the advertisement content to be provided to the user 102 via the user interface 104.

In act 834, the ad server 128 receives and processes the advertisement content response. In response to receiving the advertisement content response, the ad server 128 provides the advertisement content to the programmable device 108 in the act 836. In act 838, the programmable device 108 provides the advertisement content to the user 102 via the user interface 104. The RTB process 800 ends at 840.

In some embodiments, the programmable devices 108 and 110 exchange information with the third party systems 144. Examples of the third party systems 144 include the FACEBOOK social networking system, the TWITTER social networking and microblogging service available online from Twitter, Inc. of San Francisco, Calif., the FOURSQUARE location based social network system available online from Foursquare Labs, Inc. of New York, N.Y., the GOOGLE+ social networking system available online from Google Inc. of Mountain View, Calif., the LINKEDIN social networking system available online from Linkedin Corporation of Mountain View, Calif., mailing lists, email systems, texting systems, telephone systems, and the like. The information exchanged between the programmable devices 108 and 110 and the third party systems 144 may include data descriptive of identified users of the programmable devices 108 and 110, such as indications of the validity of logon credentials, account information, and profile information, as well as data descriptive of the social network to which the identified users belong, such as groups, friends, followers, other users commented on by the identified users, or other users who authored comments associated with the identified users. The information exchanged between the programmable devices 108 and 110 and the third party systems 144 may further include activity conducted by users of the programmable devices 108 and 110, such as activating particular user interface elements or content.

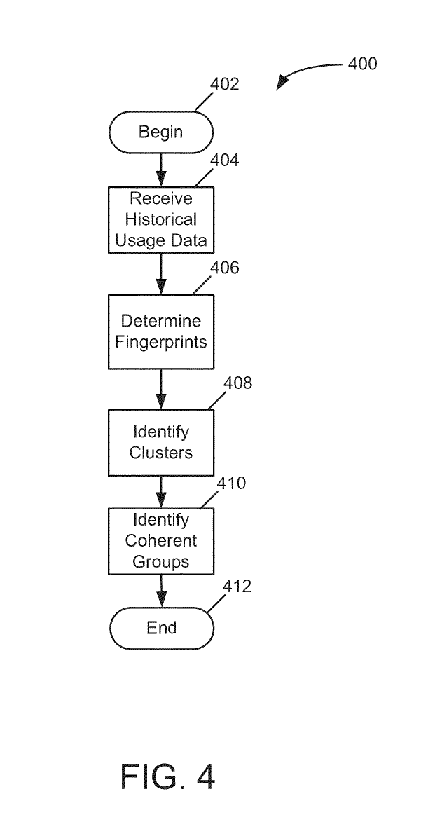

In some embodiments illustrated by FIG. 1, the user identifier 132 is configured to identify users whose activities span multiple devices. For example, when executing according to this configuration, the user identifier 132 monitors activity of the user 102 as detected by the programmable devices 108 and 110. The user identifier 132 processes data descriptive of this monitored user activity to identify one or more coherent groups within the user activity data. Examples of user activity data that the user identifier 132 is configured to process include times (as indicated by a timestamp or the like) when the user 102 provides input that results in the user interfaces 104 and 106 requesting advertisement content for provision to the user 102, the location (as indicated by an internet protocol (IP) address, global positioning system (GPS) location information, zip code, or the like) of the user 102 as detected by the programmable devices 108 and 110, and the content (as indicated by a URL, domain, application, industry vertical of a URL, industry vertical of an application, or the like) accessed by the user 102 via the programmable devices 108 and 110. Examples of processes that the user identifier 132 is configured to execute are described further below with reference to FIG. 4.

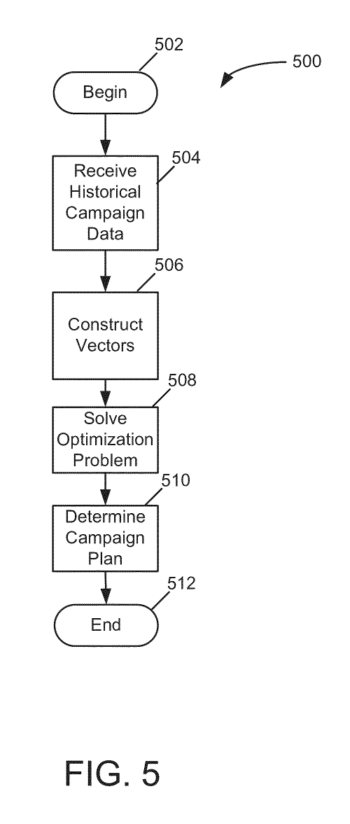

According to some embodiments illustrated by FIG. 1, the campaign manager 142 is configured to identify a mix of automated advertisement activities that, in combination, maximize return for a given marketing budget. When executing according to this configuration, the campaign manager 142 processes historical campaign information to determine a performance to cost ratio for each available advertisement channel. Examples of these advertisement channels include any permutation of the following channel elements: a type of advertisement provided (e.g., video ad, banner ad, etc.), a type of programmable device to through which advertisements are provided (e.g., mobile computing device, desktop computer, etc.), and a type of application through which advertisements are provided (e.g., social media application, non-social media application, etc.). Thus example advertisement channels include mobile social video channels, mobile non-social video channels, desktop social video channels, desktop non-social video channels, mobile social banner channels, mobile non-social banner channels, desktop social banner channels, and desktop non-social banner channels. Examples of the historical campaign information processed by the campaign manager 142 include information descriptive of users reviewing advertisements and the performance or cost for any of the channel elements or advertisement channels listed above. Examples of processes that the campaign manager 142 is configured to execute are described further below with reference to FIG. 5.

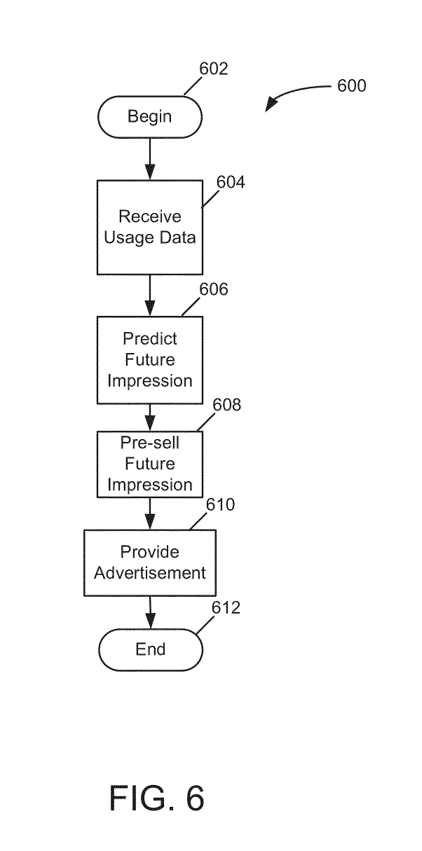

According to various embodiments illustrated by FIG. 1, the impression predictor 136 is configured to predict future impressions from user activity data and pre-sell these within an FTB process. When executing according to this configuration, the impression predictor 136 builds a statistical model of user activity relative to publisher applications for which the advertising marketplace system 116 serves advertisement content. From these statistical models, the impression predictor 136 derives impression patterns for the publisher applications. Next, the impression predictor 136 monitors user activity relative to identified publisher applications and when the activity fits precursor activity associated with impression patterns for the publisher applications, the impression predictor 136 predicts future impressions at intervals that match the impression patterns for the publisher applications. The impression predictor 136 pre-sells the predicted future impressions by triggering RTB processes actions so that, when a predicted impression is received, the ad server 128 can respond with the appropriate advertisement content with decreased latency relative to conventional RTB processes. Additional examples of processes that the user identifier 132 is configured to execute are described further below with reference to FIG. 6.

In some embodiments illustrated by FIG. 1, each ad client component 112 and 114 is configured to receive and store advertisement content via a non-cellular network connection to the advertising marketplace system 116. For example, when executing according to this configuration, the ad client component 112 monitors network connections established via the network 120 between the programmable device 108 and the advertising marketplace system 116. Responsive to detecting a non-cellular network connection to the network 120, such as a wired network connection or a Wi-Fi connection, the ad client component 112 transmits a request to update advertisement content to the ad manager component 130. In some embodiments, the ad manager component 130 is configured to receive requests to update advertisement content from ad client components, such as the ad client components 112 and 114, and respond to the requests by transmitting responses including updated advertisement content to the ad client components. This updated advertisement content may be provided to the ad manager component 130 by, for example, the impression predictor 136. In response to receiving the response from the ad manager component 130, the ad client 112 stores the updated advertisement content in a data store local to (e.g., included in) the programmable device 108. The user interface 104 may access the local data store to retrieve advertisements store therein at any point in the future, without consuming cellular bandwidth. In this way, the advertising marketplace system 116 conserves cellular bandwidth and potentially lowers data plan costs for users.

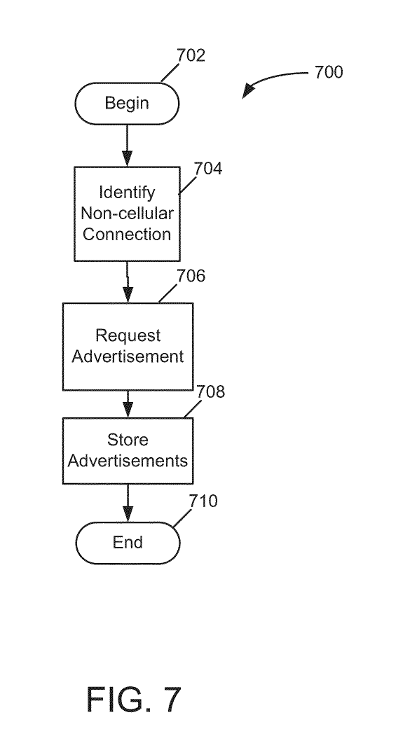

In some embodiments, the ad client components 112 and 114 are configured to limit the amount of data stored in the local data store to approximately 10 MB or less. In these embodiments, the ad client components 112 and 114 are further configured to rotate advertisement content according to a variety of prioritization schemes. These prioritization schemes may be based on a variety of attributes of the locally stored advertisement content. Examples of these attributes include the time of initial local storage of the advertisement content and the number of times the advertisement content has been provide to users. For example, according to one prioritization scheme, the ad client components 112 and 114 first replace advertisement content that has been provided the most number of times and next replace advertisement content that has been provided the second most number of times and so on until all of the updated advertisement content has been stored in the local data store. According to another prioritization scheme, the ad client components 112 and 114 first replace advertisement content that was initially stored least recently (i.e., is oldest advertisement content in the local data store) and next replace advertisement content that was initially stored next least recently (i.e., is the second oldest advertisement content in the local data store) and so on until all of the updated advertisement content has been stored in the local data store. Other prioritization schemes may be utilized according the embodiments disclosed herein. Thus the embodiments disclosed herein are not limited to a particular prioritization scheme or set of prioritization schemes. Additional examples of processes that the ad client components 112 and 144 and the ad manager component 130 are configured to execute are described further below with reference to FIG. 7.

Information may flow between the components illustrated in FIG. 1, or any of the elements, components and subsystems disclosed herein, using a variety of techniques. Such techniques include, for example, passing the information over a network using standard protocols, such as TCP/IP, HTTP, or HTTPS, passing the information between modules in memory and passing the information by writing to a file, database, data store, or some other nonvolatile data storage device, among others. In addition, pointers or other references to information may be transmitted and received in place of, in combination with, or in addition to, copies of the information. Conversely, the information may be exchanged in place of, in combination with, or in addition to, pointers or other references to the information. Other techniques and protocols for communicating information may be used without departing from the scope of the examples and embodiments disclosed herein.

Within the advertising marketplace 100, data may be stored in any logical construction capable of storing information on a computer readable medium including, among other structures, flat files, indexed files, hierarchical databases, relational databases or object oriented databases. These data structures may be specifically configured to conserve storage space or increase data exchange performance. In addition, various examples organize the data into particularized and, in some cases, unique structures to perform the functions disclosed herein. In these examples, the data structures are sized and arranged to store values for particular types of data, such as integers, floating point numbers, character strings, arrays, linked lists, and the like.

### Advertising Marketplace System

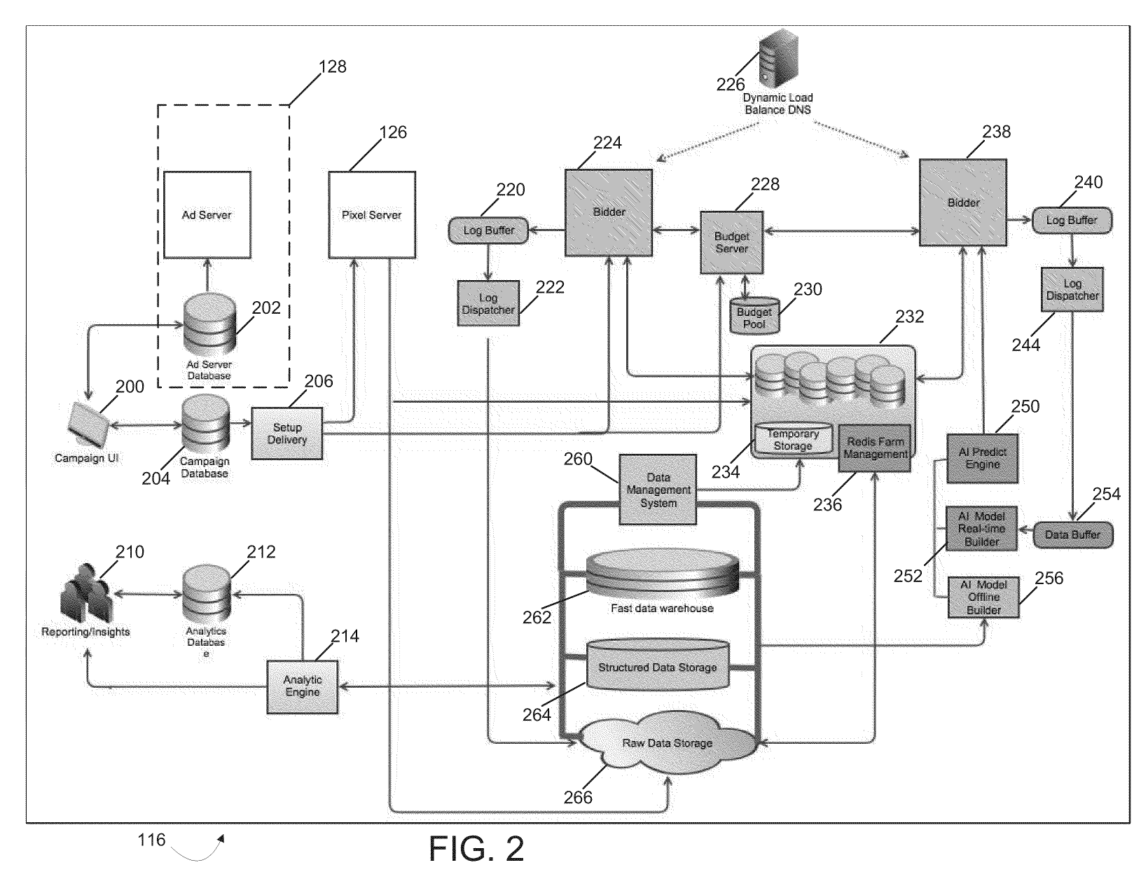

The advertising marketplace system 116 may be arranged according to a variety of architectures. FIG. 2 illustrates one such architecture in which physical and logical components of the advertising marketplace system 116 are configured as a distributed system. The architecture illustrated in FIG. 2 is provided for example purposes only and embodiments disclosed herein are not limited to the architecture shown in FIG. 2.

As shown in FIG. 2, the advertising marketplace system 116 includes the one or more ad servers 128, the one or more pixel servers 126, a dynamic load balancing DNS 226, log buffers 220 and 240, bidder components 224 and 238, a budget server 228, log dispatchers 222 and 224, a budget pool 230, a redis farm 232, a campaign user interface 200, a campaign database 204, a setup delivery component 206, a reporting component 210, an analytics database 214, an analytic engine 214, a data management system 260, an artificial intelligence (AI) prediction engine 250, an AI model real-time builder 252, a data buffer 254, and an AI model offline builder 256. The one or more data servers 128 include an ad server database 202. The data management system 260 includes a fast data warehouse 262, a structured data storage 264, and a raw data storage 266. The redis farm 232 includes a plurality of redis servers, temporary storage 234 and a redis farm management component 236.

In one embodiment illustrated by FIG. 2, the ad server 128 is configured to process impression information and advertisement content requests. More particularly, when executing according to this configuration, the ad server 128 retrieves advertisement content from the ad server database 202 and transmits the advertisement content to the programmable devices, such as the programmable devices 108 and 110 described above with reference to FIG. 1, for provision to users, such as the user 102 described above with reference to FIG. 1. In addition, in some embodiments, the ad server 128 tracks and stores usage information (e.g., click information and conversion information, such as click rates and conversion rates) in the ad server database 202.

In this embodiment, the ad server database 202 is configured to store information regarding advertisement content (e.g., creatives) and basic campaign information. In some embodiments, the ad server database 202 is configured to store information descriptive of impressions, clicks, and conversions.

Continuing with an embodiment illustrated by FIG. 2, the pixel server 126 is configured to processes requests for pixels and to map cookies to advertiser or partner cookies. The campaign user interface 206 is configured to receive input defining characteristics of a campaign including budget, advertisement content, frequency cap, impression cap, targeting criteria, tracking pixels, and other campaign characteristics. The campaign user interface 206 is also configured to store data descriptive of the campaign characteristics in the campaign database 204. The campaign database 204 is configured to store the data descriptive of the campaign characteristics. The setup delivery component 206 is configured to transmit requests to update of campaign characteristics to all real time servers that use campaign characteristics, such as the one or more pixel servers 126, the bidder components 224 and 238, and the budget server 230.

In an embodiment shown in FIG. 2, the reporting component 210 is configured to present a user interface. The user interface provides interactive visualizations of analytic results. The user interface may also provide different perspectives and deep insight into campaign performance, user behavior, and user segmentation. The analytic database 212 is configured to store aggregated analytic data. The analytic engine 214 is configured to analyze and aggregate data either periodically or responsive to detection of an event or receipt of a request.

Continuing with an embodiment illustrated by FIG. 2, the dynamic load balancing DNS 226 is configured to receive and judiciously distribute requests for bids from ad exchanges, such as the ad exchange 138 described above with reference to FIG. 1, to the bidder components 224 and 238. The bidder components 224 and 238 are configured to respond to process bid requests by calculating a bid amount based on impression information and currently configured campaign characteristics and transmit a bid response to the requesting ad exchange. The budget server 228 is configured to allocate budget information to each of the bidder components 224 and 238 and control the spending pace. The budget server is also configured to stop a campaign once the budget for the campaign is depleted. The budget pool 230 is configured to store the budget information and the temporary budget data produced during campaign execution. The log buffers 220 and 240 are configured to store a log of bid request, bid, impression, click and conversion data generated by the bidder components 220 and 238. The log dispatchers 222 and 224 are configured to read the log data from the log buffers 220 and 240 and transmit the data to the raw data storage 266 and the data buffer 254. The redis farm 232 includes one or more real-time fast in-memory data system servers that are configured to store data used by the bidder components 224 and 238. The redis farm management component 236 is configured to manage data loading, back up, and recovery of the redis farm 232 as needed. The temporary storage 234 is configured to store cookie segment data to be loaded into the redis farm 232.

In at least one embodiment illustrated in FIG. 2, the AI prediction engine 250 is configure to host artificial intelligence models that provide real-time prediction services to the bidder components 224 and 238. In some embodiments, the bidder components 224 and 238 are configured to use the AI prediction engine 250 to estimate values of particular impressions. The real-time AI model builder 252 is configured to build the AI models in real-time and online by using the data streamed through the data buffer 254. The data buffer 254 is configured to store input data for the real-time AI model builder 252. In some embodiments, data from log dispatcher 244 is transmitted into the data buffer 254 and is consumed by the real-time AI model builder 252. The offline AI model builder 256 is configured to build AI models offline using data stored in the data management system 260.

According to some embodiments illustrated in FIG. 2, the data management system 260 is configured to manage the extract, transform, and load processes that move data from the raw data storage 266 to the structured data storage 264 and further to the fast data warehouse 262. When executing according to this configuration, the data management system 260 removes outdated data in those data storages and provides data to other system components, such as the redis farm 232. The fast data warehouse 262 is configured to store large volumes of data and provide SQL-like API access to the data. When executing according to this configuration, the fast data warehouse 262 responds within 30 seconds for 90% of queries. The structured data storage 264 is configured to store data undergoing basic pre-processing and provide SQL-like API access to the data. The raw data storage 266 is configured to store raw log data descriptive of bids, impressions, clicks, conversions, pixels, and other data elements processed by the advertising marketplace system. In some embodiments, the raw data storage 266 comprises low cost data storage devices.

Data stores within the advertising marketplace system 116, such as the ad server database 202, the campaign database 204, the analytics database 212, the budget pool component 230, the data buffer 254, the temporary storage 234, the fast data warehouse 262, the structured data storage 264, and the raw data storage 266 may comprise any physical or logical construction capable of storing information on a computer readable medium including flat files, indexed files, hierarchical databases, relational databases or object oriented databases. The data may be modeled using unique and foreign key relationships and indexes. The unique and foreign key relationships and indexes may be established between the various fields and tables to ensure both data integrity and data interchange performance.

Embodiments of the advertising marketplace system 116 are not limited to the particular configuration illustrated in FIGS. 1 and 2. These configurations are included for the purposes of illustration only. It is to be appreciated that various examples and embodiments utilize a variety of hardware components, software components, and combinations of hardware and software components that are configured to perform the processes and functions described herein. In addition, in some embodiments, the hardware components described above may be virtualized. Thus the scope of the embodiments disclosed herein is not limited to a particular set of hardware, software, or a combination thereof.

### Computer System

As discussed above with regard to FIGS. 1 and 2, various aspects and functions described herein may be implemented as specialized hardware or software components executing in one or more computer systems. There are many examples of computer systems that are currently in use. These examples include, among others, network appliances, personal computers, workstations, mainframes, networked clients, servers, media servers, application servers, database servers, and web servers. Other examples of computer systems may include mobile computing devices (e.g., smart phones, tablet computers, and personal digital assistants) and network equipment (e.g., load balancers, routers, and switches). Further, aspects may be located on a single computer system or may be distributed among a plurality of computer systems connected to one or more communications networks.

For example, various aspects, functions, and processes may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, embodiments are not limited to executing on any particular system or group of systems. Further, aspects, functions, and processes may be implemented in software, hardware or firmware, or any combination thereof. Thus, aspects, functions, and processes may be implemented within methods, acts, systems, system elements and components using a variety of hardware and software configurations, and examples are not limited to any particular distributed architecture, network, or communication protocol.

Referring to FIG. 3, there is illustrated a block diagram of a distributed computer system 300, in which various aspects and functions are practiced. As shown, the distributed computer system 300 includes one or more computer systems that exchange information. More specifically, the distributed computer system 300 includes computer systems 302, 304, and 306. As shown, the computer systems 302, 304, and 306 are interconnected by, and may exchange data through, a communication network 308. The network 308 may include any communication network through which computer systems may exchange data. To exchange data using the network 308, the computer systems 302, 304, and 306 and the network 308 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST, and Web Services. To ensure data transfer is secure, the computer systems 302, 304, and 306 may transmit data via the network 308 using a variety of security measures including, for example, SSL or VPN technologies. While the distributed computer system 300 illustrates three networked computer systems, the distributed computer system 300 is not so limited and may include any number of computer systems and computing devices, networked using any medium and communication protocol.

As illustrated in FIG. 3, the computer system 302 includes a processor 310, a memory 312, an interconnection element 314, an interface 316 and data storage element 318. To implement at least some of the aspects, functions, and processes disclosed herein, the processor 310 performs a series of instructions that result in manipulated data. The processor 310 may be any type of processor, multiprocessor or controller. Example processors may include a commercially available processor such as an Intel Xeon, Itanium, Core, Celeron, or Pentium processor; an AMD Opteron processor; an Apple A4 or A5 processor; a Sun UltraSPARC processor; an IBM Power5+ processor; an IBM mainframe chip; or a quantum computer. The processor 310 is connected to other system components, including one or more memory devices 312, by the interconnection element 314.

The memory 312 stores programs (e.g., sequences of instructions coded to be executable by the processor 310) and data during operation of the computer system 302. Thus, the memory 312 may be a relatively high performance, volatile, random access memory such as a dynamic random access memory (“DRAM”) or static memory (“SRAM”). However, the memory 312 may include any device for storing data, such as a disk drive or other nonvolatile storage device. Various examples may organize the memory 312 into particularized and, in some cases, unique structures to perform the functions disclosed herein. These data structures may be sized and organized to store values for particular data and types of data.

Components of the computer system 302 are coupled by an interconnection element such as the interconnection element 314. The interconnection element 314 may include any communication coupling between system components such as one or more physical busses in conformance with specialized or standard computing bus technologies such as IDE, SCSI, PCI and InfiniBand. The interconnection element 314 enables communications, including instructions and data, to be exchanged between system components of the computer system 302.

The computer system 302 also includes one or more interface devices 316 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 302 to exchange information and to communicate with external entities, such as users and other systems.

The data storage element 318 includes a computer readable and writeable nonvolatile, or non-transitory, data storage medium in which instructions are stored that define a program or other object that is executed by the processor 310. The data storage element 318 also may include information that is recorded, on or in, the medium, and that is processed by the processor 310 during execution of the program. More specifically, the information may be stored in one or more data structures specifically configured to conserve storage space or increase data exchange performance. The instructions may be persistently stored as encoded signals, and the instructions may cause the processor 310 to perform any of the functions described herein. The medium may, for example, be optical disk, magnetic disk or flash memory, among others. In operation, the processor 310 or some other controller causes data to be read from the nonvolatile recording medium into another memory, such as the memory 312, that allows for faster access to the information by the processor 310 than does the storage medium included in the data storage element 318. The memory may be located in the data storage element 318 or in the memory 312, however, the processor 310 manipulates the data within the memory, and then copies the data to the storage medium associated with the data storage element 318 after processing is completed. A variety of components may manage data movement between the storage medium and other memory elements and examples are not limited to particular data management components. Further, examples are not limited to a particular memory system or data storage system.

Although the computer system 302 is shown by way of example as one type of computer system upon which various aspects and functions may be practiced, aspects and functions are not limited to being implemented on the computer system 302 as shown in FIG. 3. Various aspects and functions may be practiced on one or more computers having a different architectures or components than that shown in FIG. 3. For instance, the computer system 302 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 302 may be a computer system including an operating system that manages at least a portion of the hardware elements included in the computer system 302. In some examples, a processor or controller, such as the processor 310, executes an operating system. Examples of a particular operating system that may be executed include a Windows-based operating system, such as, Windows NT, Windows 2000 (Windows ME), Windows XP, Windows Vista or Windows 7 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Oracle Corporation, or a UNIX operating systems available from various sources. Many other operating systems may be used, and examples are not limited to any particular operating system.

The processor 310 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, C# (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### Advertising Marketplace Processes

As described above with reference to FIG. 1, some embodiments execute processes that identify users whose activities span multiple programmable devices. FIG. 4 illustrates an example user identification process 400 in accord with the embodiments disclosed herein. As illustrated in FIG. 4, the user identification process 400 includes acts of receiving historical usage data, calculating fingerprints, identifying clusters of fingerprint, and identifying coherent groups. The user identification process 400 begins at 402.

In act 404, historical usage data is received. In some embodiments, a user identifier, such as the user identifier 132 described above with reference to FIG. 1, receives the historical usage data. Each distinct instance of historical usage data may include information descriptive of a usage time, a usage location, and usage content. In some embodiments, the usage time identifies a time when an advertising marketplace system, such as the advertising marketplace system 116 described above with reference to FIG. 1, received an advertisement content request including impression information referencing a user from an ad server, such as the ad server 128 described above with reference to FIG. 1. The usage time may be stored as a timestamp. In some embodiments, the usage location identifies a location of a programmable device associated with the user, such as either of the programmable devices 108 and 110 described above with reference to FIG. 1. The usage location may be stored as an IP address, GPS location, or zip code. In some embodiments, the usage content characterizes the topical subject of the content being accessed by the user. The usage content may be stored as a URL, domain, application, industry vertical of the URL, or industry vertical of the application.

In act 406, fingerprints are determined and arranged in a chronologically order set within a time window having a specified size. In some embodiments, the user identifier determines the fingerprints and arranges them in chronological order. For instance, according to one embodiment, the user identifier constructs fingerprints as 3-dimensional vectors having time, location, and content components. Thus, in this embodiment fingerprint u for a first usage instance p may be expressed as uₚ=[tₚ,lₚ,cₚ]. Similarly, a fingerprint for a second usage instance q may be expressed as u_{q}=[t_{q},l_{q},c_{q}].

In act 408, clusters are determined. In some embodiments, the user identifier determines the clusters. In these embodiments, to determine clusters, the user identifier iteratively processes each pair of adjacent fingerprints (uₚⁱ,u_{q}^{j}) within the chronologically ordered set. More specifically, the user identifier records usage instances p and q as having been conducted by different users

$${MIN}_{i , j} [ L ( {u}_{p}^{i} , {u}_{q}^{j} ) ] < {H}_{1}$$

where H₁ is a configurable threshold parameter and L(uₚⁱ,u_{q}^{j}) is a link function that measures the similarity of the fingerprints (uₚⁱ,u_{q}ⁱ) by a heuristic probability value. In addition, the user identifier records usage instances p and q as having been conducted by the same user

$$S = {MAX}_{i , {i}^{′} , j , {j}^{′}} [ L ( {u}_{p}^{i} , {u}_{q}^{j} ) L ( {u}_{p}^{{i}^{′}} , {u}_{q}^{{j}^{′}} ) T ( {u}_{p}^{i} , {u}_{p}^{{i}^{′}} ) T ( {u}_{q}^{j} , {u}_{q}^{{j}^{′}} ) ] > {H}_{2} ,$$

where H₂ is a configurable threshold parameter,

$$T ( {u}_{p} , {u}_{q} ) = \frac{2 D ( {u}_{p} , {u}_{q} )}{1 + D ( {u}_{p} , {u}_{q} )}$$

and is a location transition function with a range of [1, 2) and D(uₚ,u_{q}) is a distance function. Also, within the act 408, the user identifier groups fingerprints of usage instances recorded as having been conducted by the same user into a cluster.

In some embodiments, the distance function executes a process to determine distances based on a set of rules that depend on the type of location information provided with the usage instances. For example, according to an embodiment where the location information includes longitude and latitude coordinates for each usage instance, the distance function calculates geographical distances between sets of longitude and latitude coordinate points for each usage instance and returns values equal to the calculated geographical distances.

In another example, where the location information includes IP address information, the distance function compares IP addresses of usage instances. If the IP addresses share a common top 3 bytes and belong to the same organization, the distance function returns distances of 0. In another example, where the location information includes zip code information, the distance function first translates the zip codes into longitude and latitude values and then calculates a geographical distance between each set of coordinates and returns values equal to the calculated geographical distance.

Continuing this example, where zip codes share a common value, the distance function calculates a geographical distance between the longitude and latitude of the common zip code and the longitudes and latitudes of other zip codes neighboring (e.g., adjacent to) the common zip code. In this example, the distance function identifies a geographical distance between the common zip code and a neighboring zip code closest to the common zip code and returns a value based on this geographical distance (e.g. 0.5 of the distance) as the value between the usage instances sharing the common zip code.

Embodiments of the distance function may implement a combination of the processes described above to determine a value of the distance between to usage instances. For example, in one embodiment, the distance function first attempts to determine the distance value using longitude and latitude information, where longitude and latitude information is included in the location information of the usage instances. If the longitude and latitude information is not available for some usage instances, the distance function next attempts to determine a value of the distance based on IP address information, where IP address information is included in the location information of the usage instances. If insufficient IP address information is available for some usage instances, the distance function next attempts to determine the distance value using zip code information, where zip code information is included in the location information of the usage instances. In some embodiments, where location information is available that supports determining distance values using two or more of the processes described above, the distance function returns distance values that are equal to the lowest values calculated by the supported processes. Thus, as described above, in some embodiments, the distance function implements a flexible technique in which distances are calculated based on and using whatever type of location information is available for subject usage instances.

In some embodiments, the link function is expressed as:

$$L ( {u}_{p} , {u}_{q} ) = {e}^{- D ( {u}_{p} , {u}_{q} )} {e}^{- {( \frac{{t}_{p} - {t}_{q}}{c} )}^{2}} ,$$

where tₚ and t_{q} are the time stamps in seconds, and c is a constant determined empirically (e.g., by manually approximating c and reviewing the clusters generated as a result). In these embodiments, the link function uses the time and location of usage instances p and q to determine a degree of similarity between the usage instances.

In some embodiments, the link function explained above may be further refined to reflect additional information extracted from historical usage instances. For example, after the user identifier has executed for a period of time and has created a substantial number of clusters (e.g., 1000 or more clusters), the user identifier may calculate an empirical, probability-based content similarity value based on co-occurrence of access to identified content within the usage instances of a cluster. This content similarity value may range between [0, 1]. For instance, if the content accessed in one usage instance within a cluster belongs to a baby product industry vertical and another usage instance within the cluster belongs to an RPG game industry vertical in 20% of all clusters, the content similarity value may have, for example, a low value of 0.2. These content similarity values may be incorporated with the link function explained above to further refine its accuracy. For example, in at least one embodiment, the results of the link function explained above are multiplied by the content similarity value to incorporate the content similarity value with the link function.

In act 410, coherent groups are identified. In some embodiments, the user identifier identifies the coherent groups. More specifically, the user identifier records all clusters with any two fingerprints having a similarity greater than a configurable parameter, H₃ as a coherent group. In some embodiments, the user identifier identifies coherent groups by walking a hierarchical cluster tree from each leaf pair of fingerprints to the root and recording the set of nodes visited as the coherent group. By configuring H₃ to different values, the user identifier generates coherent groups with varying numbers usage instances that reflect different levels of certainty regarding user identity.

The user identification process 400 ends at 412. Processes in accord with the user identification process 400 enable systems to track users whose activity spans two or more computer systems. In this way, processes such as the identification process 400 enable advertising systems to increase the likelihood of user conversation by increasing the relevancy of advertisements provided to the user.

As described above with reference to FIG. 1, some embodiments execute processes that identify a mix of automated advertisement activities that, in combination, maximize return for a given marketing budget. FIG. 5 illustrates an example campaign planning process 500 in accord with the embodiments disclosed herein. As illustrated in FIG. 5, the campaign planning process 500 includes acts of receiving historical campaign data, constructing vectors, solving an optimization problem, and determining a campaign plan. In combination, the acts of the process 500 derive, for every coherent user group or group of users interested in the same industry vertical or residing at the same location, a performance sensitivity factor for each of advertisement channel. The campaign planning process 500 begins at 502.

In act 504, historical campaign information is received. In some embodiments, a campaign manager, such as the campaign manager 142 described above with reference to FIG. 1, receives the historical campaign information. In act 506, the historical campaign information is encoded into vector representations. In some embodiments, the campaign manager encodes the historical campaign information into vectors that represent a single user or coherent usage group. In these embodiments, some of the vectors have components with initial Boolean values that represent whether or not an advertisement in an advertisement channel represented by the component was provided to the user represented by the vector. These vectors reside in a binary space. In these embodiments, other vectors have components with initial integer values that represent how many impressions involving the user represented by the vector have been provided advertisement content via an advertisement channel represented by the component. These vectors reside in a real number space. Further, in these embodiments, vectors representing a class of users who were converted are labeled as positive and vectors representing a class of users who were not converted are labeled as negative.

Table 1 illustrates a particular example of historical campaign information that may be encoded into a vector according to some embodiments. More particularly, Table 1 shows numbers of advertisements belonging to particular advertising channels that were served to a single user over an identified time window. To ensure that vectors have a mixed binary encoding (a “good” representation in binary space), the campaign manager may limit the identified time window to a window that includes a substantial number of vector components having a value of 0.

TABLE 1

| Advertising Channel | Number of Advertisements |
|---|---|
| mobile social video | 1 |
| mobile non-social video | 2 |
| desktop social video | 0 |
| desktop non-social video | 3 |
| mobile social banner | 0 |
| mobile non-social banner | 2 |
| desktop social banner | 3 |
| desktop non-social banner | 2 |

The vector encoding corresponding to the Table 1 is [1, 1, 0, 1, 0, 1, 1, 1] in binary space and [1, 2, 0, 3, 0, 2, 3, 2] in real number space.

In act 508, a performance sensitivity factor is determined. In some embodiments, the campaign manager determines the performance sensitivity factor. In at least one embodiment, the campaign manager determines a function ƒ(x)=<w,x>+b, which represents a vector hyperplane within the feature space x that separates positive and negative vectors. In this embodiment, the campaign manager determines the function ƒ(x)=<w,x>+b for both the binary space and the real number space by solving the following linear programming problem, which is a type of Support Vector Machine (SVM):

$$Minimize {\sum }_{i = 1}^{P} {w}_{i} + {\sum }_{k = 1}^{N} {ξ}_{k}$$

Subject to:

yₖƒ(xₖ)>1−ξₖ for all k=1 . . . N, where yₖ is a class label of k^{th} sample of historical campaign information, k (+1 or −1),

wᵢ≧0 for all i=1 . . . P, where P is the dimensionality of the vector space, and

ξⱼ≧0 for all j=1 . . . N, where N is the number of positive and negative samples. In this linear programming problem, wᵢ represents the i^{th} component of the vector w, which is normal to the hyperplane ƒ(x) w,x>+b, and ξₖ represents a soft margin error of the k^{th} sample of historical campaign information. When solved, this linear programming problem minimizes the total soft error and the norm of vector w in linear form. In some embodiments, the campaign manager determines ƒ(x) w,x>+b for the binary space and ƒ′(x)=<w′,x>+b′ for the real number space and normalizes w by w←w/∥w∥ and w′ by w′←w′/∥w′∥. Finally, in the act 508, the campaign manager derives a performance sensitivity factor cᵢ=w′ᵢ/wᵢ for all wᵢ>T, where T is a configurable parameter. The campaign manager uses this form of linear programming SVM to suppress some wᵢ to small values that are ignored. The performance sensitivity factor indicates which advertising channels are relevant in predicting positive and negative outcomes (i.e., which advertising channels are relevant in converting users. By comparing a vectors in binary space to vectors in real number space, the sensitivity factor indicates how much the advertisement channel frequency affects the wᵢ of each vector, thus indicating how relevant the impression frequency is to the final performance.

In act 510, a campaign plan is determined. In some embodiments, the campaign manager determines the campaign plan. More particularly, in some embodiments, the campaign manager suggests that no impressions in one or more advertisement channels wᵢ where wᵢ≦T be purchased. Furthermore, in these embodiments, the campaign manager suggests purchasing cᵢk impressions for all advertisement channels wᵢ>T where cᵢ>1 and k impressions for all advertisement channels wᵢ>T where cᵢ<1.

The campaign planning process 500 ends at 512. Processes in accord with the campaign planning process 500 enable systems to determine an optimal mix of advertising channels to utilize for a given advertising budget.

As described above with reference to FIG. 1, some embodiments execute processes that pre-sell impressions within an FTB process. FIG. 6 illustrates an example FTB process 600 in accord with the embodiments disclosed herein. As illustrated in FIG. 6, the FTB process 600 includes acts of receiving usage data, predicting a future impression, pre-selling the future impression, and caching advertisement content. The FTB process 600 begins at 602.

In act 604, usage data is received. In some embodiments, an impression predictor, such as the impression predictor 136 described above with reference to FIG. 1, receives the usage data. Each distinct instance of usage data may include information descriptive of a usage time, a usage location, and usage content. In some embodiments, the usage time identifies a time when an advertising marketplace system, such as the advertising marketplace system 116 described above with reference to FIG. 1, received an advertisement content request including impression information referencing a user from an ad server, such as the ad server 128 described above with reference to FIG. 1. The usage time may be stored as a timestamp. In some embodiments, the usage location identifies a location of a programmable device associated with the user, such as either of the programmable devices 108 and 110 described above with reference to FIG. 1. The usage location may be stored as an IP address, GPS location, or zip code. In some embodiments, the usage content characterizes the topical subject of the content being accessed by the user. The usage content may be stored as a URL, domain, application, industry vertical of the URL, or industry vertical of the application.

In act 606, one or more future impressions are predicted. In some embodiments, the impression predictor predicts the one or more future impressions. For instance, according to one embodiment, the impression predictor accesses a statistical model of the provider of the usage content. The provider may be, for example, a software application (e.g., an “app” on a mobile device). In this embodiment, the statistical model includes historical usage patterns detected and recorded for the software application (e.g., time intervals between consecutive impressions). Further, in this embodiment, to predict a future impression, the impression predictor determines a first threshold T₁ for the 10^{th} percentile time interval, a second threshold T₂ for the 90^{th} percentile time interval and a difference D between them. If D is smaller than a configurable parameter L representing a target lead time for the next impression, the impression predictor predicts a future impression at time T₂ after an actual impression corresponding to T_{1 is} detected.

In the act 608, the future impression is pre-sold. In some embodiments, the impression predictor initiates pre-sale of the future impression. More specifically, in these embodiments, the impression predictor transmits future impression information to an ad server, such as the ad server 128 described above with reference to FIG. 1. Next, the ad server processes the future impression information according to the act 810 described above with reference to FIG. 8. The remainder of the RTB process 800 described above with reference to FIG. 8 is executed through the act 834, at which point the ad server waits until impression information corresponding to the future impression is received from a user interface, such as the user interface 104 described above with reference to FIG. 1.

In the act 610, advertisement content is provided to the source of the impression. In some embodiments, the ad server provides the advertisement content to the user interface in response to receiving impression information corresponding to the future impression information. In other embodiments, the ad server provides the advertisement content to a data store local to a programmable device executing the user interface prior to receiving impression information corresponding to the future impression information. In these embodiments, when the future impression matures into an actual impression, the user interface provides the advertisement information from the local data store.

The FTB process 600 ends at 612. Processes in accord with the FTB process 600 enable systems reduce latency relative to a conventional RTB process.

As described above with reference to FIG. 1, some embodiments execute processes that transmit advertisement content to data storage local to programmable devices to minimize usage of cellular data plans subscribed to by the programmable devices. FIG. 7 illustrates an example advertisement caching process 700 in accord with the embodiments disclosed herein. As illustrated in FIG. 7, the advertisement caching process 700 includes acts of identifying a non-cellular network connection, requesting advertisement content, and storing the advertisement content. The advertisement caching process 700 begins at 702.

In act 704, a non-cellular network connection is detected. In some embodiments, an ad client component, such as the ad client component 112 described above with reference to FIG. 1, detects a non-cellular data connection to a network, such as the network 120 described above with reference to FIG. 1. Examples of non-cellular network data connections include wired connections, Wi-Fi connections, and the like.

In act 706, advertisement content is requested. In some embodiments, the ad client component transmits a content request via the network data connection to an ad manager component, such as the ad manager component 130 described above with reference to FIG. 1. The content request may include an identifier of the programmable device executing the ad client component, such as the programmable device 108 described above with reference to FIG. 1, or an identifier of a user of the programmable device, such as the user 102 described above with reference to FIG. 1. In some embodiments, in response to receiving the content request, the ad manager transmits a response including the advertising content.

In act 708, the advertising content is locally stored on the programmable device. In some embodiments, the ad client component stores the advertising content within a local data store. This advertisement content may include audio, video, images, and other forms of content.

The advertisement caching process 700 ends at 710. Processes in accord with the advertisement caching process 700 enable systems reduce latency and increase successful delivery of advertisement content relative to conventional advertisement delivery processes.

Each of processes 400-800 depicts one particular sequence of acts in a particular embodiment. The acts included in these processes may be performed by, or using, one or more computer systems specially configured as discussed herein. Some acts are optional and, as such, may be omitted in accord with one or more embodiments. Additionally, the order of acts can be altered, or other acts can be added, without departing from the scope of the embodiments described herein. Furthermore, as described above, in at least one embodiment, the acts are performed on particular, specially configured machines, namely an advertising marketplace system configured according to the examples and embodiments disclosed herein.

Having thus described several aspects of at least one example, it is to be appreciated that various alterations, modifications, and improvements will readily occur to those skilled in the art. For instance, examples and embodiments disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A system comprising:
memory;
at least one processor coupled to the memory;
a user identifier component executable by the at least one processor and configured to:
receive historical usage data;
determine fingerprints from the historical usage data;
identify clusters of fingerprints having a calculated similarity greater than a threshold; and
associate the clusters with a user.
